(19) United States
(12) Patent Application Publication
(10) Pub. No.: US 2001/0008929 A1
(43) Pub. Date: Jul. 19, 2001

(54) Filtrate reducing additive and well fluid

(76) Inventors: Annie Audibert-Hayet, Croissy sur Seine (FR); Jean-Francois Argillier, Suresnes (FR); Lionel Rousseau, Aubergenville (FR)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/782,309

(22) Filed: Feb. 14, 2001

Related U.S. Application Data
(62) Division of application No. 09/242,823, filed on Feb. 24, 1999, now abandoned.

(30) Foreign Application Priority Data
Jun. 24, 1997 (FR) 97/07.980

(51) Int. Cl. C09K 7/02

(52) U.S. Cl. 526/287; 524/547; 507/226; 507/224; 507/225; 507/227; 507/228

(57) ABSTRACT

The invention concerns a water-based additive for well fluid, comprising an acrylamide and branched styrene sulphonate copolymer. It also concerns a water-based fluid comprising an acrylamide and branched styrene sulphonate copolymer. The additive is useful for controlling the filtering of a well fluid through the wall. The invention is advantageously applicable to drilling and/or completion of oil wells having a temperature higher than 120° C.

### FIELD OF THE INVENTION

Wells drilled into the subsoil at great depths or having a high bottomhole temperature require stable drilling fluids with satisfactory properties as regards the bottomhole environment, notably the temperature. The products of the present invention have satisfactory filtering and viscosity properties up to temperatures of about 200° C. They can therefore be advantageously used in conventional well fluid formulations or in formulations containing low solid amounts, or for formulations weighted by means of mineral products or soluble salts.

### BACKGROUND OF THE INVENTION

The well-known products that are generally offered for higher temperatures generally contain AMPS type functions, described in document U.S. Pat. No. 5,510,436 for example. Additional work showed that, from a certain temperature and after a certain aging time, these AMPS functions hydrolyse with the temperature, thus making the product very sensitive to molecular degradation by decarboxylation (see publication SPE-28,953-Oil Field Chemistry International Meeting, San Antonio, February 1995). The products of the present invention are stabilized by incorporation of styrene sulphonate functions that are highly temperature stable.

### SUMMARY OF THE INVENTION

The present invention thus relates to an acrylamide and styrene sulphonate copolymer containing at least 30% styrene sulphonate functions. The molecular mass can range between 100,000 and 10⁷, preferably between 500,000 and 5 10⁶.

The copolymer is a product branched with a branching product.

The branching agent can be incorporated during polymerization, in which case covalent agents are used, or after polymerization in a post-branching stage.

The covalent agents can be monomers with diethylene unsaturation (diacrylate esters such as polyethylene glycol PEG diacrylates for example) or polyethylene unsaturation such as, for example, N,N′-methylenebisacrylamide (MBA), or a well-known acrylic branching agent, or more generally a diallylamine, allylether type structure.

The post-branching agents can be polyvalent metal salts, formaldehyde, glyoxal.

Other features and advantages of the present invention will be clear from reading the description of tests hereafter.

### DESCRIPTION OF THE TESTS

The copolymers (S1, S3a, S3b, S3c, S3d) tested in the tests hereafter have the following structure of general formula:

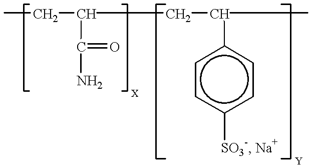

The polymers used (bearing series reference number S1) in these comparative tests with one of the products according to the invention (S3a, S3b, S3c, S3d) are:

unbranched acrylamide/styrene sulphonate copolymers with a mole ratio of about 50/50, that come in the form of aqueous solutions containing 10 to 25% active substances,

acrylamide derivatives (acrylamide/acrylate copolymer) manufactured by the SNF Floerger-France Company,

sulphonated derivatives (AMPS/vinylamide/acrylamide, Hostadrill manufactured by the Hoechst Company for example),

cellulose derivatives (CMC) manufactured by the Aqualon Company or the Lamberti Company (Italy) for example.

Series S3 is different from series S1 in the branched structure thereof. Among the four product structures (S3a, S3b, S3c, S3d), there are two weakly branched long-chained copolymers and two more branched short-chained copolymers. The branching agent used here is N,N′-methylenebisacrylamide (MBA) of general structure (CH₂=CHCONH)₂CH₂. The transfer agent used in synergy with the branching agent in order to increase branching is sodium hypophosphite (NaH₂PO₂).

| | Proportion of | | |
|---|---|---|---|
| | branching | Proportion of transfer | |
| | agent/active | agent/active | PM × 10⁶ |
| Sample reference | (ppm) | (ppm) | (g/mol) |
| S1 | — | — | 1 |
| S3a | 10 | 0 | 2.2 |
| S3b | 50 | 0 | 3.5 |
| S3c | 500 | 5000 | — |
| S3d | 1000 | 5000 | — |

NB: The molecular mass of samples S3c and S3d is difficult to measure on account of the branching of these polymers even for high LiNO₃ concentrations (up to 1 M). It is however possible to estimate that the molecular mass of these samples ranges between 2 and 4×10⁶ g/mol.

Test 1: Study of the temperature stability of the unbranched and branched acrylamide/styrene sulphonate copolymers S1, S3a, S3b, S3c and S3d, and comparison with an AMPS/vinylamide/acrylamide terpolymer (Hostadrill produced by the Hoechst Company) and a conventional weakly hydrolyzed polyacrylamide (2% acrylate functions, produced by SNF Floerger):

The test conditions are as follows:

Temperature:180° C. and aging from 24 hours to 72 hours in a HP/HT test cell with a back pressure of 10 bars.

Solutions: Preparation and aging in deionized water between 3000 and 10000 ppm of polymer. Deaeration by nitrogen stripping of the solutions up to oxygen proportions ranging between 5 ppb and 50 ppb.

[η] is the intrinsic viscosity of the polymer obtained from relative viscosity measurements at various concentrations and extrapolated at zero concentration. [η]/[η]₀ corresponds to the evolution of the intrinsic viscosity after thermal aging.

Characterizations : Carried out in KCl 5 g/l after addition of the salts.

| | | | | | |
|---|---|---|---|---|---|
| | | | Proportion of | Proportion of | |
| | | | carboxylate | sulphonated | Proportion |
| Temperature | | | functions | functions | of O₂ |
| ° C. | Time | [η]/[η]₀ | (%) | (%) | (ppb) |

Polyacrylamide

| Initial | — | 1 | 3 | — | — |
|---|---|---|---|---|---|
| 100 | 5 days | — | 70 | — | <5 |
| 100 | 14 days | 0.25 | 90 | — | <5 |

HOSTADRILL

| Initial | — | 1 | 31 | 55 | — |
|---|---|---|---|---|---|
| 130 | 14 days | 0.46 | 22 | 40 | <5 |
| 150 | 3 days | — | 20 | 44 | <5 |
| 170 | 3 days | 0.53 | 41 | 23 | <5 |

Product S1

| Initial | — | 1 | 2.4 | 50 | — |
|---|---|---|---|---|---|
| 180 | 3 days | 0.85 | 37.7 | 50 | 10 |

Product S3a

| Initial | — | 1 | 2 | 50 | — |
|---|---|---|---|---|---|
| 180 | 3 days | 0.57 | 23.5 | 50 | 10 |

Product S3b

| Initial | — | 1 | 1.2 | 50 | — |
|---|---|---|---|---|---|
| 180 | 3 days | 0.53 | 26.4 | 50 | 10 |

Product S3c

| Initial | — | 1 | 1.6 | 50 | — |
|---|---|---|---|---|---|
| 180 | 3 days | 0.52 | 28.6 | 50 | 10 |

Product S3d

| Initial | — | 1 | 2 | 50 | — |
|---|---|---|---|---|---|
| 180 | 3 days | 0.44 | 27.5 | 50 | 10 |

NB: It should be noted that the polyacrylamide is totally degraded at 100° C. There is a loss of viscosity (only 25% of the initial viscosity is left) and hydrolysis of the acrylamide functions (there are 90% carboxylate functions). The sulphonated functions of HOSTADRILL hydrolyze from 150° C. on a short-term basis and the polymer loses 50% of its viscosity. Comparatively, the branched acrylamide/styrene sulphonate copolymers keep their sulphonated functions even after aging at 180° C. Furthermore, the branched products according to the invention are less sensitive to hydrolysis.

Test 2: Comparison of the efficiency of the branched Styrene Sulphonate/Acrylamide copolymers with S1 and of the filtrate reducers used for high temperatures, for clay-based fluids:

Conditions: API standard, ambient temperature (25° C.).

Base formulation FB : GREEN BOND clay 30 g/l, xanthan 2 g/l, NaCl 10 g/l−d= 1.03

| | | | | | Filtrate | |
|---|---|---|---|---|---|---|
| | Filtrate | | | Cake | pH | Filtrate |
| Additive to FB | 30 min | VP | YV | 60 min | value | viscosity (25° C.) |
| Low-viscosity CMC 10 g/l | 5.5 | 28 | 24 | 1.5 | 9.2 | 2.4 |
| HOSTADRILL 10 g/l | 5.4 | 30 | 50 | 1.5* | 8.6 | 1.3 |
| S1 10 g/l m.a | 6 | 21 | 38 | <2 | 9 | 2.3 |
| S3d 10 g/l m.a | 5.7 | 23 | 44 | 1.3 | 8 | 2 |

*The cake of the formulation containing HOSTADRILL is fluid and is closer to a gel structure than to a cake structure proper.

The plastic viscosity (VP) and the viscosity of the filtrate are expressed in centipoise (cP), the yield value (YV) is expressed in pound/100 square ft, the 30′ filtrate in milliliter (ml) and the cake thicknesses in millimeter (mm).

The xanthan of brand name IDVIS and the low-viscosity CMC used are marketed by the DOWELL-IDF Company.

NB : The filtering properties at 25° C. of the formulation containing the branched acrylamide/styrene sulphonate copolymer are similar to those of the low-viscosity CMC and of HOSTADRILL, at lower plastic viscosity values.

Test 3: Influence of temperature

Conditions: API standard, in a HP/HT test cell with a pressure of 50 bars and a back pressure of 15 bars.

Base formulation FB: GREEN BOND clay 30 g/l, xanthan 2 g/l, NaCl 10 g/l−d= 1.03.

| | | | | | | |
|---|---|---|---|---|---|---|
| | Filtrate | | | Cake | Filtrate | Filtrate viscosity |
| Additive to FB | 30 mn | VP | YV | 60 min | pH value | at 30° C. |

Filtering temperature: 120° C.

| | | | | | | |
|---|---|---|---|---|---|---|
| HOSTADRILL 10 g/l | 15.5 | 30 | 50 | 3.5 | 7.4 | 1.1 |
| S1 10 g/l m.a | 16.7 | 26 | 38 | 2.5 | 7.1 | 1.3 |
| S3d 10 g/l m.a | 17.1 | 23 | 44 | 3.3 | 6.3 | 1 |

Filtering temperature: 140° C.

| | | | | | | |
|---|---|---|---|---|---|---|
| Low-vis. CMC 10 g/l | 21.5 | 28 | 24 | 4 | 7.2 | 1.3 |
| S3d 10 g/l m.a | 20.1 | 23 | 44 | 3.4 | 6.6 | 1.2 |

Filtering temperature: 160° C.

| | | | | | | |
|---|---|---|---|---|---|---|
| Low-vis. CMC 10 g/l | >300 | 28 | 24 | — | — | — |
| HOSTADRILL 10 g/l | 28 | 30 | 50 | 3.5 | 7.9 | 8.8 |
| S1 10 g/l m.a | 20.5 | 26 | 38 | 3 | 8 | 1.5 |
| S3a 11 g/l m.a | 23.8 | 21 | 32 | 3 | 6.8 | 1.6 |
| S3b 9 g/l m.a | 19.7 | 21 | 38 | 3 | 6.8 | — |
| S3c 10 g/l m.a | 18.9 | 22 | 38 | 2.5 | 7 | 1.1 |
| S3d 8 g/l m.a | 19.9 | 22 | 42 | 2.7 | 7.2 | 1.2 |
| S3d 10 g/l m.a | 19.2 | 23 | 44 | 2.5 | 6.6 | 1.1 |

Filtering temperature: 180° C.

| | | | | | | |
|---|---|---|---|---|---|---|
| HOSTADRILL 10 g/l | * | * | * | * | * | * |
| S1 10 g/l m.a | 27.1 | 26 | 38 | 3.5 | 7.5 | 1.7 |
| S3d 10 g/l m.a | 20 | 23 | 44 | 2.6 | 6.1 | 1.2 |

*These values are not given because the fluid is totally gelled.

NB: At 160° C., the formulation containing HOSTADRILL shows a loss of its filtering properties since the filtrate, highly viscous, points to a degradation of the product in spite of a high yield value (YV). Comparatively, the formulations based on branched acrylamide/styrene sulphonate copolymer give lower amounts of filtrate, even when the concentration is decreased in the formulation, and with lower yield values and filtrate viscosities close to the solvent. At 180° C., the brown filtrate and complete gelation, after cooling, of the formulation containing HOSTADRILL confirm the results obtained at 160° C. This has not been observed with the formulations containing the branched acrylamide/styrene sulphonate copolymers, but the 30′ filtrates are constant whatever the temperature and the cake permeability decrease from 120° C. Degradation of the low-viscosity CMC at 160° C. in this type of formulation can be noted.

Test 4: Comparison of the efficiency of the branched acrylamide/styrene sulphonate copolymers with a styrene sulphonate homopolymer

Conditions: API standard, in a HP/HT test cell with a pressure of 50 bars and a back pressure of 15 bars.

Base formulation FB: GREEN BOND clay 30 g/l, xanthan 2 g/l, NaCl 10 g/l−d= 1.03.

| | | | | | | |
|---|---|---|---|---|---|---|
| | Filtrate | | | Cake | Filtrate | Filtrate viscosity |
| Additive to FB | 30 min | VP | YV | 60 min | pH value | at 30° C. |

Filtering temperature: 160° C.

| | | | | | | |
|---|---|---|---|---|---|---|
| Styrene Sulphonate | 30.8 | 20 | 34 | <9 | 6.6 | 3.3 |
| homopolymer | | | | | | |
| 10 g/l m.a | | | | | | |
| S1 10 g/l m.a | 22.2 | 26 | 38 | 3 | 7.5 | 1.3 |
| S3d 10 g/l m.a | 19.2 | 23 | 44 | 2.5 | 6.6 | 1.1 |

NB : Using a branched acrylamide/styrene sulphonate copolymer allows to decrease the volume filtered and the thickness of the filter cake. Comparatively, the results obtained with a sulphonated homopolymer are not as good as those obtained with the copolymers presented here.

Test 5: Influence of thermal aging (160° C.)

Conditions: In a HP/HT test cell, with a pressure of 50 bars and a back pressure of 15 bars, but after 16-hour aging at a temperature of 160° C.

Base formulation FB : GREEN BOND clay 30 g/l, xanthan 2 g/l, NaCl 10 g/l−d=1.03.

| | | | | | | | Filtrate |
|---|---|---|---|---|---|---|---|
| | | | | | Cake | Filtrate | viscosity |
| | Filtrate | Va/ | | | 60 | pH | at |
| Additive to FB | 30 min | VA₀ | VP | YV | min | value | 30° C. |
| HOSTADRILL | 18.9 | 0.69 | 23 | 30 | 3 | 7.4 | 1 |
| S1 10 g/l m.a | 24.8 | 0.58 | 18 | 16 | 3 | 8.3 | 1.3 |
| S3d 10 g/l m.a | 21.9 | 1.1 | 31 | 36 | 2.9 | 6.1 | 1.3 |

VA: apparent viscosity
VA₀: initial apparent viscosity

NB: Branching of the acrylamide/styrene sulphonate copolymers allows to obtain a better temperature resistance of the formulations and to keep quite acceptable filtering properties.

Test 6: Comparison of the efficiency, under dynamic conditions, of a formulation based on branched styrene sulphonate/acrylamide copolymer with commercial formulations used for high temperatures:

MMH, marketed by IDF-DOWELL,

THERMADRILL, marketed by BAROID.

Conditions: Rotating speed: 1000 rpm, dP=35 bars, ambient temperature (25° C.). The methodology of dynamic filtering was applied as described in the document by Y. LI et al., Revue IFP, vol.52, No.2, March-April 1997.

Base formulation FB: GREEN BOND clay 30 g/l, xanthan 2 g/l, NaCl 10 g/l−d=1.03.

| Additive to | Commercial | Filtrate | | | | Filtrate |
|---|---|---|---|---|---|---|
| FB | formulations | 30' | VP | YV | Slope | TOC |
| | MMH | 13 | — | — | 0.009 | 800 |
| | THERMADRILL | 22 | — | — | 0.018 | 1300 |
| Low-vis. | | 8 | 28 | 24 | 0.005 | 1000 |
| CMC 10 g/l | | | | | | |
| S1 10 g/l | | 10 | 21 | 38 | 0.005 | 200 |
| m.a | | | | | | |
| S3d 10 g/l | | 6 | 23 | 44 | 0.004 | 700 |
| m.a | | | | | | |

The plastic viscosity (VP) is expressed in centipoise (cP), the yield value (YV) is expressed in pounds/100 square ft, the 30′ filtrate in milliliter (ml), the slope in cm/minute and the total organic concentration of the filtrates (TOC) is expressed in ppm of carbon.

NB: In dynamic filtering, the formulation containing the branched acrylamide/styrene sulphonate copolymers has the best filtering properties and thus contributes to reducing the cake permeabilities, hence lower carbon concentrations in the filtrates in relation to the commercial formulations.

Test 7: Comparison of the efficiency of the branched styrene sulphonate/acrylamide copolymers with filtrate reducers used for high temperatures, for fluids based on filling clay and calcite, for formation damaging limitation.

Conditions: API standard, ambient temperature (25° C.).

Base formulation FB1 :Xanthan 4 g/l, HYMOD PRIMA (or HMP) 28.5 g/l, NaCl 20 g/l, KCl 20 g/l, IDCARB75 360 g/l−NaOH 2M for pH value=9.5−d=1.20.

| | Filtrate | | | Gel | Gel | Cake | Filtrate |
|---|---|---|---|---|---|---|---|
| Additive to FB | 30° | VP | YV | 0 | 10 | 120′ | TOC |
| Low-vis. CMC | 3.3 | 17 | 30 | 10 | 13 | 1 | from |
| 10 g/l | | | | | | | 700 to |
| | | | | | | | 1000 |
| HOSTADRILL 5 g/l | 7.7 | 39 | 24 | 10 | 17 | 1.8 | 900 |
| S1 5 g/l m.a | 6.9 | 14 | 22 | 9 | 14 | 1.6 | 700 |
| S3d 5 g/l m.a | 6.7 | 15 | 22 | 10 | 18 | 1.4 | 900 |

The plastic viscosity (VP) is expressed in centipoise (cP), the yield value (YV), Gel 0 and Gel 10 are expressed in pounds/100 square ft, the 30′ filtrate in milliliter (ml), the cake thicknesses in millimeter (mm) and the total organic concentration (TOC) of the filtrates is expressed in ppm of carbon.

HYMOD PRIMA, or HMP, is a filling clay marketed by the DOWELL-IDF Company, as well as the calcite IDCARB75 whose grain size ranges from 0.1 to 10 μm.

NB: The formulations containing HOSTADRILL or the acrylamide/styrene sulphonate copolymers have comparable filtering properties under these conditions, but the latter have lower plastic viscosities. An increasing carbon concentration, from 700 to 1000 ppm is observed throughout filtering for the formulation based on low-viscosity CMC, which is not observed with the formulations containing the branched acrylamide/styrene sulphonate copolymers.

Test 8 : Influence of temperature (110° C.)

Conditions: API standard, in a HP/HT test cell with a pressure of 50 bars and a back pressure of 15 bars.

Base formulation FB1 : Xanthan 4 g/l, Hymod Prima (HMP) 28.5 g/l, NaCl 20 g/l, KCl 20 g/l, IDCARB75 360 g/l−NaOH 2M for pH=9.5−d=1.20.

| | Filtrate | | | Gel | Gel | Cake | Filtrate |
|---|---|---|---|---|---|---|---|
| Additive to FB | 30° | VP | YV | 0 | 10 | 120′ | TOC |
| Low-vis. CMC | 13.5 | 17 | 30 | 10 | 13 | 9.4 | from |
| 10 g/l | | | | | | | 600 to |
| | | | | | | | 900 |
| HOSTADRILL 5 g/l | 40.1 | 39 | 24 | 10 | 17 | 5.5 | 1600 |
| S1 5 g/l m.a | 26.6 | 14 | 22 | 9 | 14 | 3.9 | 1500 |
| S3d 5 g/l m.a | 35.1 | 15 | 22 | 10 | 18 | 4.4 | 1600 |

NB: At 110° C. and in this type of formulation, HOSTADRILL loses its filtering properties (30′ filtrate and cake thickness increase), unlike the formulations containing the branched acrylamide/styrene sulphonate copolymers. The great thickness of the cake observed for the formulation containing the low-viscosity CMC confirms a degradation of the product and the loss of its properties, which has not been observed for the formulations containing the branched acrylamide/styrene sulphonate copolymers. Claims

1. A well fluid additive, characterized in that it comprises an acrylamide and styrene sulphonate copolymer consisting of at least 30% styrene sulphonate functions and in that said copolymer is branched by means of a branching agent.

2. An additive as claimed in claim 1, wherein the branching agent is selected from the following group:
monomers with diethylene or polyethylene unsaturation,
polyvalent metal salts, formaldehyde, glyoxal.

3. An additive as claimed in claim 2, wherein said branching product is N,N′-methylenebisacrylamide.

4. An additive as claimed in any one of the previous claims, wherein the acrylamide/styrene sulphonate mole ratio is about 50/50.

5. An additive as claimed in any one of the previous claims, wherein the molecular mass of said branched copolymer ranges between 500,000 and 5 10⁶, preferably between 2 10⁶ and 4 10⁶ g/mol.

6. Water-base well fluid, characterized in that it comprises an additive as claimed in any one of claims 1 to 5.

7. Application of the additive as claimed in any one of claims 1 to 5 to control filtering of a well fluid through the wall of said well.

8. Application as claimed in claim 7 for wells whose temperature is higher than 120° C.
